(19) United States
(12) Patent Application Publication
(10) Pub. No.: US 2011/0202409 A1
(43) Pub. Date: Aug. 18, 2011

(54) USING LANGUAGE INSERTION TO PROVIDE TARGETED ADVERTISEMENTS

(75) Inventor: Anand Chandrasekaran, San Jose, CA (US)

(73) Assignee: OPENWAVE SYSTEMS INC., Redwood City, CA (US)

(21) Appl. No.: 13/028,186

(22) Filed: Feb. 15, 2011

Related U.S. Application Data
(60) Provisional application No. 61/304,732, filed on Feb. 15, 2010.
(60) Provisional application No. 61/406,572, filed on Oct. 25, 2010.

(51) Int. Cl. G06Q 30/00

(52) U.S. Cl. 705/14.67

(57) ABSTRACT

A system and method for providing targeted advertisements are provided. The system and method involve receiving a request message from a request source for a content element hosted by a content source. A request description is inserted into the request message for use in selecting a targeted advertisement, whereby the request description contains information about the request source. The request description is sent to the content source, and after receiving a response message that includes a targeted advertisement that was selected based on the request description, the response message is sent to the request source.

### CROSS-REFERENCE TO RELATED APPLICATION

This application is entitled to the benefit of provisional U.S. Patent Application Ser. No. 61/406,572, filed Oct. 25, 2010 and provisional U.S. Patent Application Ser. No. 61/304,732, filed Feb. 15, 2010, both of which are incorporated by reference herein.

### BACKGROUND

When browsing certain webpages, a user may be presented with an advertisement. However, information about the user may not be readily available to servers hosting the webpages. Therefore, it can be difficult to provide a targeted advertisement that is relevant to the user and this in turn decreases the potential revenue generated from such advertisements as the click-through rate is typically a function of the relevance of the advertisement. The less relevant the advertisement, the less likely it is that a user will click through.

### SUMMARY

A method for providing targeted advertisements to users is disclosed. In an embodiment, a request message is received from a request source for a content element hosted by a content source. A request description is inserted into the request message for use in selecting a targeted advertisement, whereby the request description contains information about the request source. The request description is sent to the content source, and after receiving a response message that includes a targeted advertisement that was selected based on the request description, the response message is sent to the request source. In one embodiment, the request description includes a request source identifier configured to enable selection of the targeted advertisement using request source information that was obtained based on the request source identifier.

A method in accordance with an embodiment of the invention includes receiving a targeted advertisement request from a content source, the targeted advertisement request being based on a language segment that was inserted into a content element request by a language insertion engine in an access network that intercepted the content element request. The content element request is initiated by a request source and is sent to the content source via the access network, and the language segment includes information about the request source. Using the language segment, a targeted advertisement based on the information about the request source is requested.

A method for providing a targeted advertisement to a request source connected to an Internet-accessible content source through an access network in accordance with an embodiment of the invention includes intercepting, within the access network, a request message from the request source for a content element hosted by the content source. The method further includes inserting, within the access network, a language segment into the request message, whereby the language segment enables a targeted advertisement to be selected and sent to the request source along with the content element via the access network and the Internet. The targeted advertisement is selected based on information about the request source, the information being obtained using the language segment.

A system in accordance with an embodiment of the invention includes a language insertion engine configured to insert a request source identifier into a request message for a content element that was sent from a request source to a content source via an access network, whereby the request source identifier is related to the request source and is used to select a targeted advertisement. The system further includes an analytics server configured to obtain request source information using the request source identifier, the analytics server further configured to request the targeted advertisement using the request source information.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of a system for transferring communications between a request source and an advertisement-supported content source in accordance with an embodiment of the invention.

FIG. 2 depicts a schematic diagram of communications between a request source and a content source through an access network in accordance with an embodiment of the invention.

FIG. 3 depicts an example of message contents transmitted through the system for targeted advertisement delivery in accordance with an embodiment of the invention.

FIGS. 4A and 4B depict examples of information used for targeted advertisement delivery in accordance with an embodiment of the invention.

FIG. 5 depicts a computer that includes a processor, memory, and a communications interface.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

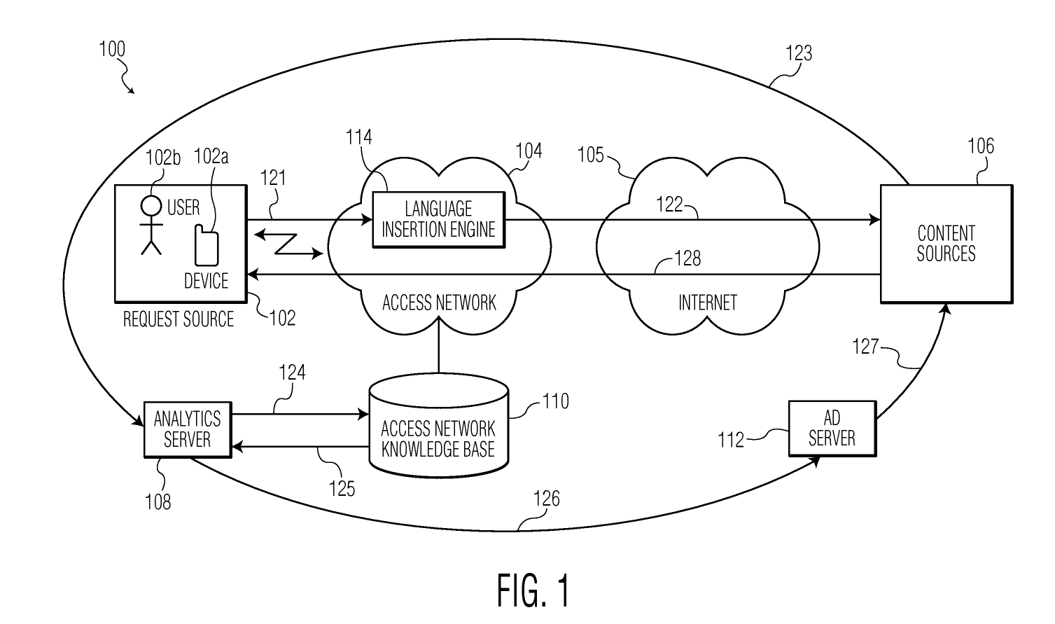

FIG. 1 depicts a system 100 for transferring communications between a request source 102 and an advertisement-supported content source 106 in accordance with an embodiment of the invention. The request source is connected to the content source through an access network 104 and through the Internet 105. The system of FIG. 1 may include more than one request source and more than one content source connected to each other through the access network. The request source 102 corresponds to a request source device 102a and/or a user 102b of the request source device.

The request source device 102a is a network enabled device including, without limitation, a mobile phone, smart phone, personal digital assistant (PDA), laptop, tablet, or personal computer (PC). The user 102b is a user of the request source device and the user is generally a subscriber to a wireless communications service or a subscriber to an Internet Service Provider (ISP). Oftentimes, a user and a request source device are linked to the same subscriber account. For example, a wireless communications service account links a particular wireless device and a particular user.

In one embodiment, the request source device 102a is a wireless device that can support various different RF communications protocols, including without limitation, Global System for Mobile communications (GSM), Universal Mobile Telecommunications System (UMTS), Code Division Multiple Access (CDMA), Worldwide Interoperability for Microwave Access (WiMax) and communications protocols as defined by the 3^{rd} Generation Partnership Project (3GPP) or the 3^{rd} Generation Partnership Project 2 (3GPP2), 4G Long Term Evolution (LTE) and IEEE 802.16 standards bodies. Although some wireless communications protocols are identified herein, it should be understood that the present disclosure is not limited to the cited wireless communications protocols.

The content source 106 is any device or system that hosts content elements. In one embodiment, the content source is an Internet-connected host or server that is identified by a URI or a URL and that hosts Internet-accessible content elements. Content sources are well known in the field. The content source is, for example, a web server that can be accessed via Hypertext Transfer Protocol (HTTP), Internet Message Access Protocol (IMAP), or File Transfer Protocol (FTP). A content element is any data suitable to be transferred in a networked environment, such as markup language files, scripting language files, video files, music files, image files or other data files. In a non-limiting example, the content element includes an HTML file.

The request source device 102a accesses the content source by connecting to the Internet via the access network 104. For example, an HTTP request for a content element that is hosted by the content source 106 is generated at the request source device and is transmitted to the content source over a Transmission Control Protocol/Internet Protocol (TCP/IP) connection through the access network and the Internet.

The access network 104 provides a communications interface for the request source device 102a to access the Internet 105. Typical access networks include wireless service provider networks (e.g., that offer 3G, 4G and/or WiFi access) and ISPs (e.g., that offer dial-up, DSL, and cable modem access). A private enterprise network can also serve as the access network if client devices within the private enterprise network can access the Internet through the private enterprise network.

In one embodiment, the access network 104 is a wireless service provider network that provides a wireless communications interface for the request source device 102a (e.g., wireless device such as smartphone or tablet). In an embodiment, the wireless service provider network is accessible on a subscription basis (e.g., prepaid or post-paid) as is known in the field. In an embodiment, the wireless service provider network is a closed domain that is accessible only by subscribers (e.g. users of the request source device 102b) that are in good standing with the operator of the wireless service provider network. The wireless service provider network may include a radio access network (not shown) and an Internet gateway (not shown). The radio access network includes one or more base stations to facilitate communications among wireless devices that are within a communication range of the base stations. Each base station has at least one RF transceiver and the base stations communicate with the wireless devices using RF communication signals. The radio access network facilitates network communications among multiple wireless devices within the same wireless service provider network and between wireless devices in other wireless service provider networks and provides interfaces to facilitate communications with other entities, such as a Public Switched Telephone Network (PSTN), a Wide Area Network (WAN), the Internet, Internet servers, hosts, etc., which are outside of the wireless service provider network. In an embodiment, the wireless service provider network is operated by a single wireless service provider, such as, for example, AT&T, VERIZON, T-MOBILE, or SPRINT. In one embodiment, the wireless service provider has exclusive access to and control over the wireless service provider network.

Data signals communicated between the wireless device 102a and the access network 104 include, but are not limited to, analog and/or digital RF signals (i.e., radio waves) for any type of communication mode, including text messaging, multimedia messaging, voice calling, and Internet browsing. The radio access network can support various different RF communications protocols, including without limitation, GSM, UMTS, CDMA, WiMax and communications protocols as defined by 3GPP, 3GPP2, or IEEE 802.16. Although some wireless communications protocols are identified herein, it should be understood that the present disclosure is not limited to the cited wireless communications protocols.

The Internet gateway (not shown) of the access network 104 provides a gateway for communications between the wireless devices 102a and Internet-connected hosts and/or servers, which can also be referred to as the “cloud.” The Internet gateway may include a Serving General Packet Radio Service (GPRS) Support Node (SGSN) and a Gateway GPRS Support Node (GGSN). For example, the Internet gateway can be a Wireless Application Protocol (WAP) gateway that converts the WAP protocol used by the access network (such as a wireless service provider network) to the HTTP protocol used by the Internet. In an embodiment, the Internet gateway enables the wireless devices to access multimedia content, such as HTML, compact HTML (cHTML), and extensible HTML (xHTML), which is stored on Internet-connected hosts and/or servers. In this way, the access network provides access to the Internet for its subscribers.

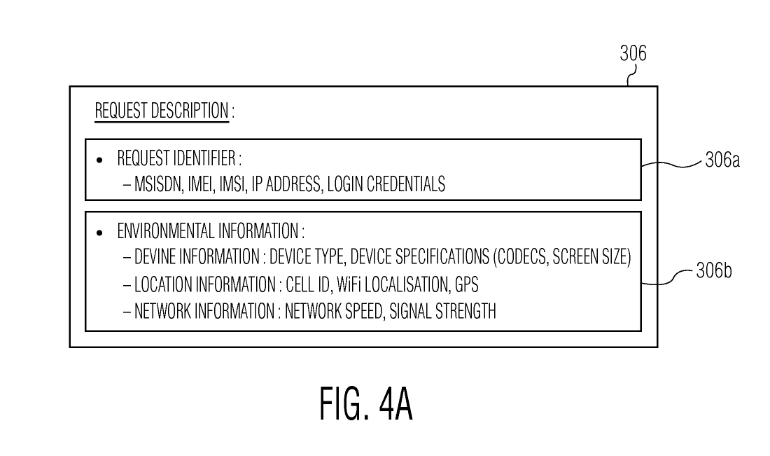

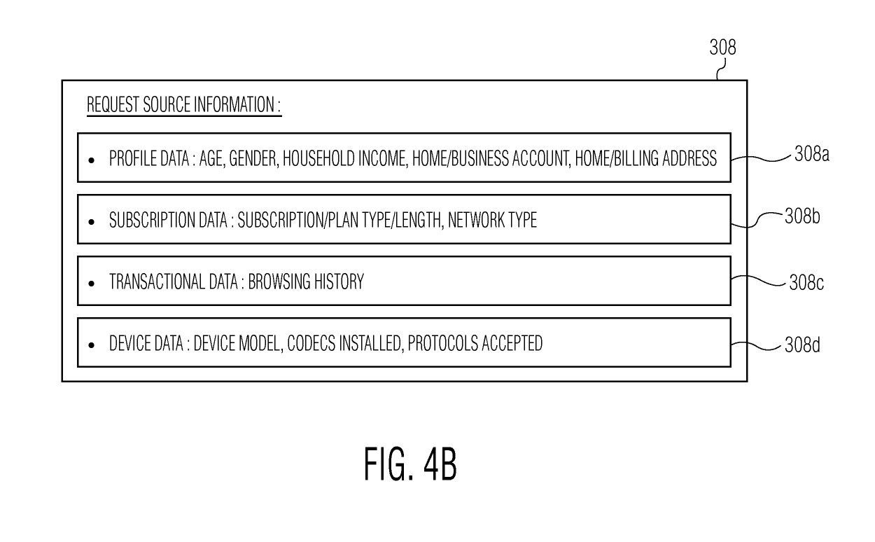

The analytics server 108 is a server that is configured to receive requests for a targeted advertisement that is tailored to the request source 102 (e.g., device 102a and/or user 102b), for example by using information about the request source. In one embodiment, the analytics server is accessed via an Application Programming Interface (API). The information about the request source (device and/or user) is obtained by querying an access network knowledge base 110, such as a knowledge base that includes information held by an operator of the access network. The particular type of information held by the access network knowledge base about the request source device and/or user is described in more detail with reference to FIG. 4B below.

As shown in FIG. 1, the access network 104 includes a language insertion engine 114 and the access network is operatively coupled to the access network knowledge base 110. The access network knowledge base contains information about the request source 102 (e.g., device 102a and/or user 102b) that can be useful in advertisement selection, as will be described in more detail below. The access network knowledge base is configured to receive requests from the analytics server 108 for information about the request source, referred to herein as request source information. In one embodiment, the request source network knowledge base contains request source information that can otherwise not be deduced or derived from a typical content element request (such as a standard HTTP request) and is otherwise not available to the content source 106. The access network knowledge base contains request source information such as, in a non-limiting example, information about the request source device (e.g. device type, codecs installed on the device, protocols accepted by the device) and/or information about a user of the request source device (e.g. user's age, gender, household income, home/billing address/ZIP code etc). For example, in a wireless environment, a request source (e.g., mobile subscriber) makes a request to download a website and the request to download the website is sent to the host of the website via a wireless access network. As is known in the field, the content elements that make up the website may include one or more advertisements. Typically, the website host would have no knowledge of any specific information about the request source, such as the user's home address that can be used to select a relevant advertisement. However, because the operator of the wireless access network has knowledge about the request source (e.g., the user's home address), the wireless access network can be configured to inject information that is specific to the request source into the website request, thereby allowing the host website to provide a more relevant advertisement based on the information about the request source. As a result, more relevant advertisements can be selected for the request source, such as, for example, advertisements for local restaurants around the user's home address. Examples of the type of information that can be retrieved from the access network knowledge base are described in more detail with reference to FIG. 4B.

Although FIG. 1 is described with respect to a wireless device 102a and a wireless access network 104, the techniques are not limited to wireless devices or wireless access networks and similarly apply to wired devices and wired access networks or a combination of wired and wireless devices and/or access networks.

The operation of a technique for providing targeted advertisements is now described with respect to FIG. 1. In the example of FIG. 1, the request source device 102a requests a content element from a content source 106 (as indicated by arrow 121). The content element request is, for example, an HTTP request, but other types of requests are also possible. Because the language insertion engine 114 is in the access network 104 or accessible by the access network, the language insertion engine is in the data path of requests between the request source and the content source. Therefore, the HTTP request can be intercepted by the language insertion engine and the language insertion engine can insert a language segment, such as script or markup language characters, into the HTTP request. Language insertion is done for example as described in U.S. Patent Application Ser. No. 61/304,732 filed Feb. 15, 2010, which is incorporated herein by reference. In one embodiment, the language segment is code that can be executed at the content source. For example, the language segment consists of scripting language strings and is written as a JavaScript (e.g. servlet) or as a Common Gateway Interface (CGI) script.

The HTTP request, including the inserted language, is then forwarded to the appropriate content source 106 (as indicated by arrow 122) via the Internet 105. Instead of the content source requesting an advertisement from the ad server 112 and returning the content element with the selected advertisement to the request source device 102a, the language segment inserted into the HTTP request has the effect of enabling the content source to obtain a targeted advertisement based on information held by, and exclusive to, the operator of the wireless access network 104 about the request source (e.g., the wireless device and/or the user of the wireless device). In one embodiment of FIG. 1, the inserted language segment causes the content source to contact the analytics server 108 (as indicated by arrow 123). In one embodiment, the analytics server provides an API to facilitate communication between the content source and the analytics server, and the language segment inserted into the HTTP request calls the API associated with services provided by the analytics server. In one embodiment, the language segment includes at least two parts, where the first part includes a redirect part and the second part includes a request description. The redirect part invokes a redirect of the content element request, including the request description, to the analytics server, and the redirect is invoked when, for example, the redirect part is executed at the content source. In one embodiment, the language segment invokes a redirect of the content element request from the content source to the analytics server as described above. In another embodiment, the content element request is redirected to the access network knowledge base 110 and the analytics server is bypassed, in which case the analytics server can be omitted.

The request description contains either or both of a request identifier and environmental information. The request identifier uniquely identifies the wireless device 102a and/or the user 102b of the wireless device (e.g. subscriber). In a non-limiting example, the request identifier is a Mobile Subscriber Integrated Services Digital Network Number (MSISDN), International Mobile Equipment Identity (IMEI), and/or International Mobile Subscriber Identity (IMSI). The request identifier represents a unique identifier of the wireless device that is typically only available to the operator of the access network 104 and is not contained in standard HTTP requests (without the inserted language segment) received at the content source 106. The environmental information includes information about the wireless device, such as device type, location information, or other information pertaining to the wireless device. In an embodiment, the environmental information (for example Cell ID) is obtained by the language insertion engine by analyzing the communication between the request source device and the access network (for example a WAP communication). Alternatively or additionally, the request source device is configured to send additional information to the access network (for example GPS signals).

In one embodiment, the request for the targeted advertisement includes the request description and a return address where the targeted advertisement is to be sent (the return address, for example, being given by a link that is included in the content element request). In one embodiment, after receiving the request for the targeted advertisement, the analytics server 108 contacts the access network knowledge base 110 (as indicated by arrow 124) and receives the information about the wireless device 102a and/or the user 102b of the wireless device (request source information, e.g. age of the user) in response (as indicated by arrow 125). The request for the targeted advertisement can further contain an indication as to what type of information about the wireless device or the user of the wireless device should be used to select the targeted advertisement. For example, the content source may want to target advertisements based on age information of a user. If no indication pertaining to the type of information to be used is given in the request for the targeted advertisement, then the analytics server requests information from the access network knowledge base about the wireless device and/or user. If multiple different items of information about the wireless device and/or user are available, the analytics server can decide which information about the wireless device and/or user is most important to use in advertisement selection.

In one embodiment, after receiving the request source information from the access network knowledge base 110, the analytics server 108 sends a request for an advertisement to the ad server 112 (as indicated by arrow 126), where the advertisement request includes the request source information and possibly at least some of the request description. The ad server then returns an advertisement to the content source 106 (as indicated by arrow 127), where the advertisement is selected based on the request source information and/or the request description such that the advertisement is targeted to the specific request source 102 (i.e., the wireless device and/or the user). The content source sends the content element and the targeted advertisement to the wireless device 102a (as indicated by arrow 128). In another embodiment, the request description contains environmental information that is used by the analytics server to obtain a targeted advertisement from the ad server. Because the language insertion engine is in the data path and under control of the access network operator, the access network operator can influence advertisement selection and can help provide more relevant advertisements to the request source. In one embodiment, the language insertion engine retrieves the request source information from the access network knowledge base and inserts the request source information into the content element request. The language insertion engine then sends the content element request with the inserted request source information to the content source. Subsequently, the content source requests a targeted advertisement based on the request source information.

Although the above-described technique is described as being used in an environment that involves a request for a content element (e.g., a WAP and/or an HTTP request) that is sent from a wireless device 102a via a wireless service provider network 104 or via a wireless hotspot, the technique is applicable to requests sent from devices that access the Internet through other types of access networks. For example, the technique is applicable to requests from wired devices via a wired access network (e.g., cable modem, DSL, dial-up, enterprise, etc).

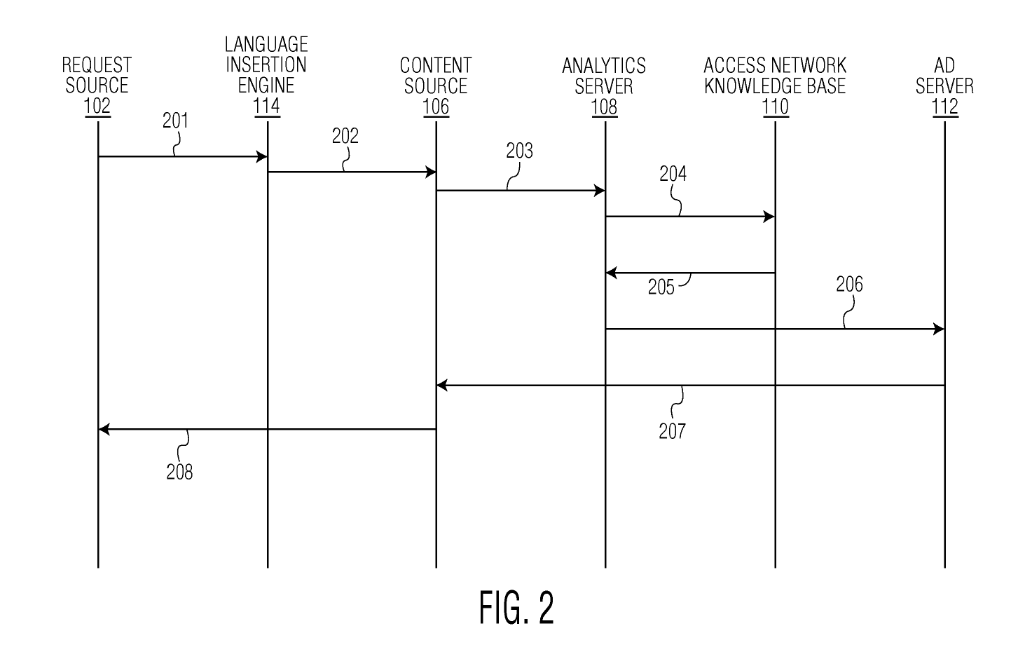

FIG. 2 depicts communications between the request source 102 and the content source 106 through the access network 104 in accordance with an embodiment of the invention. FIG. 2 helps to illustrate the temporal relationship of communications between the elements described with respect to FIG. 1. In the example of FIG. 2, the request source sends a content element request to the content source for a content element that is hosted by the content source (message 201). In an embodiment, the content element request is triggered by a user 102b of the request source device 102a selecting a link (e.g. URL) in a web browser. In a non-limiting example, the request is an HTTP request. The content element request is intercepted by the language insertion engine 114 within the access network 104, such as a scripting engine in the communication path between the subscriber and the content source. FIG. 2 is described with respect to a script insertion in particular, although other implementations are possible, such as described above with reference to FIG. 1.

The language insertion engine 114 inserts a script into the content element request and forwards the modified content element request to the content source 106 (message 202). The script includes a request description describing environmental parameters of the request source 102 (e.g. location from cell ID) and/or identifying the request source. In the case of a user 102b of a wireless device 102a for example, the request description is deduced from a gateway of the access network receiving a mobile web request. The information included with the script includes information describing the request (request description) such as the request identifier (identifying the request source device and/or user) that would otherwise not be forwarded by the gateway to the content source. The script may additionally or alternatively cause the content source to communicate with another device, such as the analytics server 108 before sending a response to the request source.

In the example of FIG. 2, the content source 106 sends a communication to the analytics server 108 upon receiving the modified content element request that includes the script (message 203). In one embodiment, the communication includes the number of targeted advertisements required by the content source and information about the original content element request and/or about the modified content element request. The analytics server is configured to use the communication to obtain detailed information about the request source 102 (request source information) from the access network knowledge base 110 (messages 204 and 205). The request source information is obtained using the request identifier (such as, for example, IMSI. See FIG. 4A). The request source information includes specific information about the source of the request, as described with reference to FIG. 4B. In one embodiment, the analytics server uses the request source information to request an advertisement from the ad server 112 (message 206), where the advertisement is specifically targeted for the request source as given by the request source information. For example, the advertisement is targeted to the user or to the request source device regardless of the user. Additionally or alternatively, the analytics server uses the request description relating to the request source's environment (such as location, time of day, etc) to request a targeted advertisement. In an embodiment, the ad server selects the targeted advertisement based on the request description and/or the request source information. The ad server then sends the targeted advertisement to the content source (message 207). Subsequently, the content source sends the content element including the targeted advertisement to the request source that initially requested the content element (message 208).

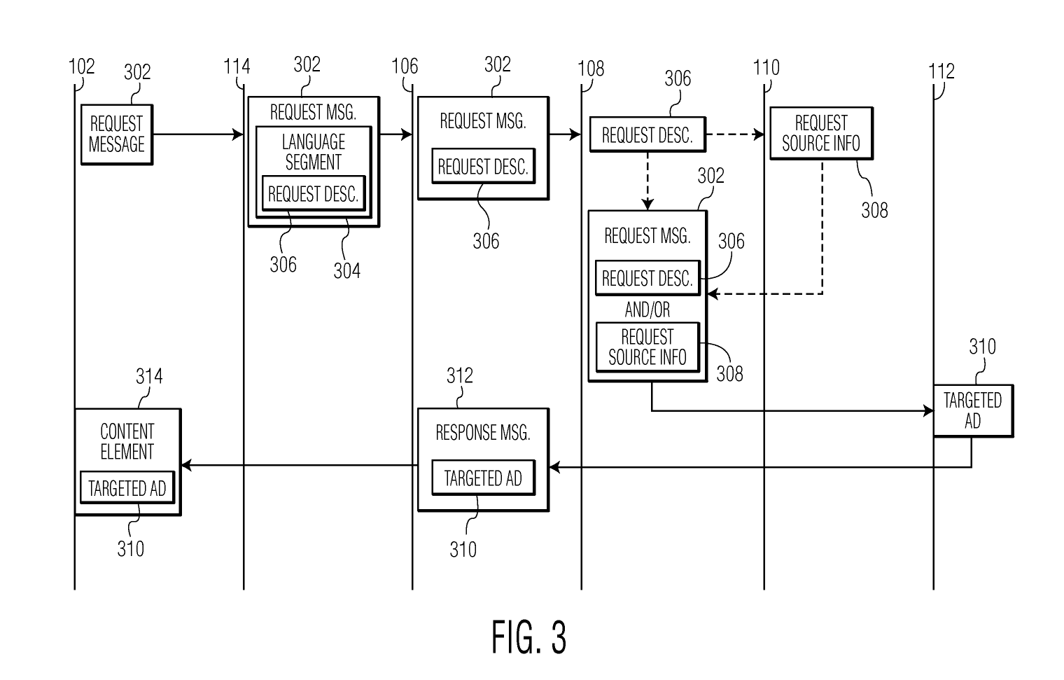

FIG. 3 depicts an example of the contents of the messages that are transmitted through the system of FIG. 1 in accordance with an embodiment of the invention. In FIG. 3, the same reference numbers as in FIG. 1 are used to identify similar elements. In the example of FIG. 3, a request message 302 is generated at the request source 102 and sent to the content source 106 via the access network 104. The language insertion engine 114 intercepts the request message and inserts a language segment 304 into the request message, the language segment including at least a request description 306. The request message, including the request description, is then sent to the content source 106, where the language segment invokes access to the analytics server 108.

In one embodiment, the request description includes a request identifier (not shown) that uniquely identifies the request source 102. The request identifier is forwarded to the access network knowledge base 110 by the analytics server 108 in order to obtain request source information 308, whereby the request source information contains specific information about the request source (device and/or user) and the request source is identified using the request identifier. In another embodiment, the request description contains environmental information (not shown) about the request source, such as location information. The environmental information is then used by the analytics server to obtain a targeted advertisement.

The request source information (if obtained by the analytics server) and/or at least parts of the request description are recombined with at least parts of the request message, and a targeted advertisement is requested from an ad server 112 using the request source information (e.g. user's age, gender, billing address) and/or the request description (e.g. device type, location information). The ad server uses at least a part of the request message to send the targeted advertisement 310 to the correct content source 106. For example, a pointer to the content source, which is retrieved from the request message, is used by the ad server to send the targeted advertisement to the content source that requested the targeted advertisement. The content source builds a response message 312 based on the request message and sends the response message along with the targeted advertisement to the request source 102, whereby the response message contains the requested content element 314. In one embodiment, the response from the content source is divided into more than one message (e.g., multiple IP packets) and the content element is created at the request source using the multiple messages.

In one embodiment, the content source 106 directly contacts the access network knowledge base 110 to obtain request source information and to request an advertisement based on the request source information. However, when using the analytics server 108 as an intermediary, private and confidential information about the request source 102 is shielded from the content source, since the request source information is not sent to the content source. For example, the advertisement request from the analytics server can be made anonymous by sending the request source information without a request identifier that is specific to the request source. Parts of the request identifier pertaining only to the request itself (such as time/date or location information) can be sent to the ad server 112 without compromising anonymity. If the request identifier solely represents location information, the step of contacting the access network knowledge base can be omitted and a targeted advertisement is directly requested from the ad server by the analytics server using the location information.

FIGS. 4A and 4B depict examples of information used for targeted advertisement delivery in accordance with an embodiment of the invention. In the example of FIG. 4A, a request description 306 is shown. In one embodiment, the request description can only be obtained using information sent during a content element request from the request source device 102a to the access network 104 and the request description is inserted into a communication between the access network and the content source 106 by the language insertion engine 114. The request description includes a request identifier 306a and/or environmental information 306b. The request identifier is, in a non-limiting example, an MSISDN, IMEI, IMSI, IP address, login credentials, or any information uniquely identifying the request source device and/or the user of the request source device. The environmental information includes, for example, device information (such as the device type) or device specifications (such as codecs installed on the device). The environmental information may also include location information, such as location based on Cell ID, WiFi networks, Global Positioning System (GPS), or a combination thereof. The environmental information may further include information about the network speed between the request source device and the access network or the Internet. Information about the network speed (such as signal strength for a mobile device) can help in acquiring an appropriate targeted advertisement that is suited for the particular network speed.

In the example of FIG. 4B, request source information 308 is shown. In one embodiment, the request source information includes profile data 308a relating to the registered subscriber of the request source device. The profile data includes, for example, demographic based information about age, gender, home address, household income, etc. The request source information can also include subscription data 308b, such as account type (home or business, pre-paid or subscription, cost of subscription, status of subscription), the network used to communicate with the internet, etc. Additionally or alternatively, the request source information includes transactional information 308c such as browsing history of the subscriber.

The request source information is obtained from the access network knowledge base using, for example, the unique identifier to obtain the required information (e.g. demographic based information). The information in the access network knowledge base is obtained when a subscriber signs up to the access network's service (for example, a mobile service provider). At the time the subscriber signs up to the access network's service, information pertaining to the subscriber is typically requested (e.g. date of birth, home address etc.) and this information is then typically stored in a database, such as the access network knowledge base. The access network knowledge base may be updated on regular intervals or as needed in order to account for changes in home address, browsing history, and other information.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital versatile disk (DVD).

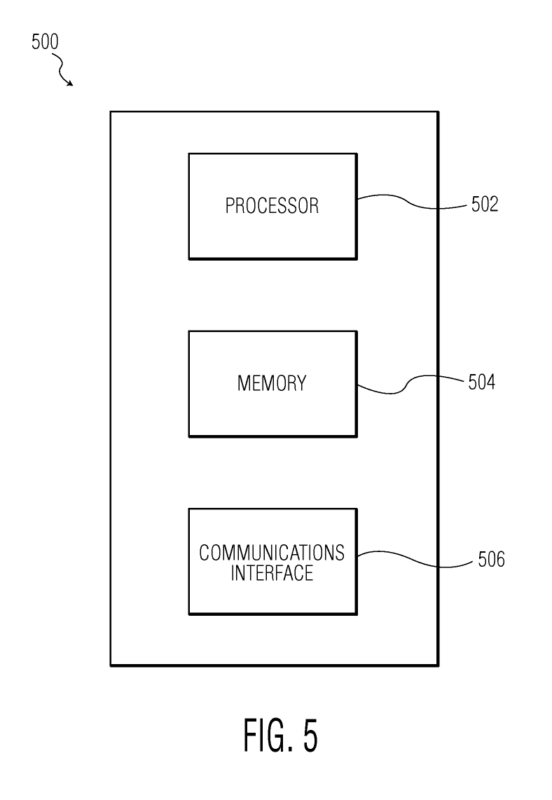

In an embodiment, the functionality of at least some of the components depicted in FIGS. 1-4 is performed by a computer that executes computer readable instructions. FIG. 5 depicts a computer 500 that includes a processor 502, memory 504, and a communications interface 506. For example, the language insertion engine 114, the analytics server 108, the access network knowledge base 110 and/or the ad server may be implemented in hardware and/or software and are, in a non-limiting example, implemented in a server, such as a file server, database server, web server or any other type of dedicated or shared server. The processor may include a multifunction processor and/or an application-specific processor. Examples of processors include the PowerPC™ family of processors by IBM and the x86 family of processors by Intel. The memory within the computer may include, for example, storage medium such as read only memory (ROM), flash memory, RAM, and a large capacity permanent storage device such as a hard disk drive. The communications interface enables communications with other computers via, for example, the Internet Protocol (IP). The computer executes computer readable instructions stored in the storage medium to implement various tasks as described above.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method comprising:
receiving a request message from a request source for a content element hosted by a content source;
inserting a request description into the request message for use in selecting a targeted advertisement, wherein the request description contains information about the request source;
sending the request description to the content source;
receiving a response message that includes a targeted advertisement that was selected based on the request description;
sending the response message to the request source.

2. The method of claim 1, wherein the request description includes a request source identifier configured to enable selection of the targeted advertisement using request source information that was obtained based on the request source identifier.

3. The method of claim 1, wherein the request description is encoded in a scripting language.

4. The method of claim 1, wherein the request description is at least one of: MSISDN, IMEI, IMSI, location information.

5. The method of claim 2, wherein the request source information is at least one of: age of a user of the request source, gender of the user, household income of the user, account type of the user, home address of the user.

6. The method of claim 1, wherein the request description is sent to the content source as part of a language segment, wherein the language segment is configured to be executed at the content source and when executed invokes an access to an API, wherein the API enables the content source to obtain the targeted advertisement.

7. A method comprising:
receiving a targeted advertisement request from a content source, the targeted advertisement request being based on a language segment that was inserted into a content element request by a language insertion engine in an access network that intercepted the content element request, the content element request being initiated by a request source and being sent to the content source via the access network, wherein the language segment includes information about the request source; and
using the language segment to request a targeted advertisement based on the information about the request source.

8. The method of claim 7, wherein the information about the request source is sent to an ad server to request the targeted advertisement.

9. The method of claim 8, wherein the information about the request source includes one of: location information, signal strength of the request source, device type of the request source.

10. The method of claim 7, wherein the information about the request source is used to obtain detailed information about the request source from a database operatively connected to the access network that is between the request source to the content source.

11. The method of claim 10, wherein the detailed information about the request source includes at least one of: age of a user of the request source, gender of the user, household income of the user, account type of the user, home address of the user.

12. The method of claim 7, wherein the targeted advertisement is sent to the content source for insertion into the content element.

13. The method of claim 7, wherein the targeted advertisement request is sent to an ad server, wherein the targeted advertisement request includes an address of the content source, wherein the targeted advertisement is sent to the content source from an ad server using the address.

14. The method of claim 7, wherein the language segment is a scripting language.

15. A method for providing a targeted advertisement to a request source connected to an Internet-accessible content source through an access network, the method comprising:
within the access network, intercepting a request message from the request source for a content element hosted by the content source;
within the access network, inserting a language segment into the request message;
wherein the language segment enables a targeted advertisement to be selected and sent to the request source along with the content element via the access network and the Internet, wherein the targeted advertisement is selected based on information about the request source, the information being obtained using the language segment.

16. The method of claim 15, wherein the information is included in the language segment.

17. The method of claim 15, wherein the language segment includes a request source identifier, wherein the request source identifier is used to obtain the information.

18. A device comprising:
a language insertion engine configured to insert a request source identifier into a request message for a content element that was sent from a request source to a content source via an access network, wherein the request source identifier is related to the request source and is used to select a targeted advertisement; and
an analytics server configured to obtain request source information using the request source identifier, the analytics server further configured to request the targeted advertisement using the request source information.

19. The device of claim 18, wherein the access network is a wireless communications network and the request source is a wireless device.

20. The device of claim 19, wherein the request source identifier is exclusive to an operator of the access network.

21. The device of claim 18, wherein the request source information is obtained from an access network knowledge base, wherein the access network knowledge base accessible by the access network and under control of the access network.
